(19) United States
(12) Patent Application Publication
(10) Pub. No.: US 2014/0008377 A1
(43) Pub. Date: Jan. 9, 2014

(54) PAINT CONTAINER

(71) Applicant: Raymond Findleton, Courtice (CA)

(72) Inventor: Raymond Findleton, Courtice (CA)

(21) Appl. No.: 13/937,431

(22) Filed: Jul. 9, 2013

Related U.S. Application Data
(60) Provisional application No. 61/669,237, filed on Jul. 9, 2012.

(51) Int. Cl. B44D 3/12; B65D 1/44

(52) U.S. Cl. CPC B44D 3/128; B65D 1/44
USPC 220/671; 220/695; 220/676

(57) ABSTRACT

An apparatus for use with a paintable liquid and with a connector that is configured to connect to a stationary object. The apparatus includes a paint container that is configured to operatively contain the paintable liquid once the paintable liquid is received in the paint container. The paint container includes a wall that is configured to surround, at least in part, the paintable liquid being received in the paint container. The wall includes a connector receiver that is configured to cooperatively engage with the connector once the connector is positioned relative to the connector receiver.

### CROSS-REFERENCE TO RELATED PATENT APPLICATION

This patent application is a nonprovisional of and claims the benefit of priority from U.S. Provisional Patent Application No. 61/669,237, filed Jul. 9, 2012, which is hereby incorporated by reference in its entirety.

### BACKGROUND

1. Technical Field

This invention relates to the field of containers, and more particularly to containers that hold paintable liquids for use in painting, construction, and related activities.

2. Description of Related Art

Buildings and physical structures such as fences and bridges generally require painting when newly constructed, as well as periodic repainting, to maintain a fresh, clean, and attractive appearance. Two types of painting instruments are commonly used, rollers and brushes. Paint rollers are generally appropriate for painting large open surface areas such as walls and doors, while paint brushes are typically used for smaller and finer areas such as window frames, trim, fences, baseboards, deck edges, and wall and ceiling intersections.

When painting it is necessary to have a container to hold the paint being applied. In particular, when using a brush a painter will typically hold the brush with one hand and the container with the other hand. In many paint projects the painter will move about extensively, including climbing scaffolding and ladders, to brush paint in the various places where detail work is required. Painter mobility for extended periods is particularly the case in large or professional paint jobs. Accordingly, it is desirable to have a paint container that is comfortable to hold, particularly for long periods, and that is not too heavy.

For each brush application the paint brush is usually first dipped in the paint so that it is completely immersed. When removed the brush is usually soaked and dripping with excess paint. The painting does not usually proceed with the brush in this condition since there is a risk that too much paint will be applied to the surface being painted. Also, when moving the brush to the paint surface there is a chance that random drops of excess paint will drip onto the floor, making a mess. Accordingly, the brush is usually wiped or dabbed to reduce the excess, and to produce a desired paint profile on the brush that is suitable for the particular surface being painted.

Brush wiping generally involves scraping or moving a broad side of the brush against an edge, and is an effective means of removing most of the paint from the portion of the brush being wiped. The movement usually begins at or near the top of the brush, where the bristles join the brush handle, and proceeds down the bristles towards their unattached or free end. The movement is stopped at whatever point it is desired to leave paint on the brush. It is desirable if the edge used for wiping is at least as wide as the brush being wiped, since that reduces the likelihood that repeated wiping strokes will be needed.

A typical profile produced by wiping is a line of paint along the bottom edge or free end of the brush. Further variations are possible in that the paint may be left only along a portion of the bottom edge, or even just a corner, rather than along the whole edge. The brush wiping profile is useful for fine work where care must be taken to avoid getting paint on a surface adjacent to the surface being painted. This may include, for example, painting the part of a window frame adjacent to the glass windowpane.

Brush dabbing involves laying all or a portion of a broad side of the soaked brush against a dabbing surface so that the excess drips off or is removed by adhesion. The brush may be “tapped” lightly to accelerate the process. The dabbing movement is continued until the desired amount of paint is left on the side of the brush being dabbed. For efficiency purposes, to reduce the need for overlapping and extra dabbing strokes, it is desirable for the dabbing surface to be at least as wide as the brush being dabbed. The resulting paint profile on the brush is a relatively uniform coat having a desired thickness, without any dripping excess. Dabbed brushes are well suited for painting broad areas that are not finely detailed and that are too narrow to be served by rollers, such as baseboards, for example.

The above described container and brush application features are helpful in improving painting efficiency. However, many of the devices and containers in current use or that have been proposed lack or inadequately address these desired features.

For example, the containers in which paint is commonly sold present a number of problems. Large paint cans that hold one gallon (about 3.79 litres) are too large and heavy, at about 7½ inches high, 6½ inches in diameter, and 10-12 lbs. in weight, to be conveniently carried for any length of time. Further, the only available surface for wiping and dabbing is the narrow and curved rim of the can, which is far from optimal.

Further problems are also caused by the wire handle that is usually provided for these cans. The handle extends in a semicircle over the top of the can, and can therefore obstruct the opening and interfere with easy insertion of the paint brush into the can. To avoid this, the painter will sometimes shift weight to displace the handle, which can cause wrist strain. The painter may put less paint in the can, to reduce the weight and therefore the wrist strain. However, this approach forces the painter to reach deeper into the can, which both slows the process and often results in paint from the rim getting on the painter's arm. The wire handle itself can dig into the painter's hand, which is obviously uncomfortable.

Some paint containers have become available which replace the wire handle with an alternative type of semicircular handle. However, in this design the container is held from the bottom, and the painter is required to put down the brush and use both hands to put down or pick up the container. This is not only inconvenient, but can result in a loss of balance when working on a ladder.

The smaller size retail paint cans are generally more manageable, being about 5 inches in height, 4¾ inches in diameter, and weighing about 4 lbs. Unlike the larger cans it is possible to hold the small cans directly in one hand without a handle. However, the diameter of the cans is still large enough to be uncomfortable for many people to hold. Further, even stronger or larger people who are initially comfortable may experience some hand strain after holding a can of this diameter for extended periods. In addition, the cylindrical shape of the can provides a poor gripping surface and is susceptible to slipping, particularly when wet. Dropping such a can could not only create a mess but also present a risk of injury.

Another aspect of the small cans is that the open top is only about 3¼ inches in diameter. The small cans therefore could not be used with paint brushes that are four inches in width, and would be awkward and inconvenient when used with the popular three inch brush size. In addition, the only surface available for wiping and dabbing is the rim, which is not only narrow like the rim of the large cans, but has an even more pronounced curvature due to its smaller diameter.

As a result of the above problems with retail paint cans, it is common for painters to make their own ad hoc paint containers out of everyday items such as, for example, old margarine containers or cut-off plastic juice bottles. These containers however continue to suffer from many of the same problems such as being uncomfortable to hold, having inadequate wiping and dabbing surfaces, and low paint capacity in some cases.

Some attempts have been made in the past to provide a convenient paint container. For example, U.S. Design Pat. No. 401,704 to Clark discloses a paint dispenser with a brush wipe and rest, and an indented handle. However, the brush wipe is a bar across the top opening, which partly obstructs the opening and compels the painter to take care not to hit the bar when inserting the brush. The brush wipe also cannot function as a dabbing surface. In addition, the handle appears difficult to grip comfortably because it is positioned at the bottom of the container, and because it forces part of the user's thumb to press against an unindented portion.

Another example is Shea, U.S. Pat. No. 6,105,816, which discloses a painter's aid to hold paint, a paint brush rest, and a stepped wiping surface. One problem with Shea is that the gripping surface is a smooth, relatively large diameter cylinder similar to the retail paint cans described above. Therefore, the device will likely be uncomfortable to hold and prone to slippage. Another problem is that the brushed wiping surface is substantially within the body of the container. Attempts to wipe the brush may therefore result in the brush picking up more paint if the bristle tips make contact with the paint. There is also no dabbing surface provided. As shown in FIG. 15, the platform 22 is used as a brush rest. Dabbing on the platform 22 would cause it to be covered in paint, which is contrary to its use as a brush rest.

### SUMMARY

According to an aspect of the present invention, there is provided an apparatus for use with a paintable liquid and with a connector being configured to connect to a stationary object, the apparatus comprising:

a paint container being configured to operatively contain the paintable liquid once the paintable liquid is received in the paint container to do just so, the paint container including:

a wall being configured to surround, at least in part, the paintable liquid being received in the paint container, the wall including:

a connector receiver being configured to cooperatively engage with the connector once the connector is positioned relative to the connector receiver to do just so, in such a way that the connector connects the connector receiver to the stationary object, and the paintable liquid remains surrounded by the wall and remains within the container.

According to another aspect of the present invention, there is provided a container for holding paintable liquid, the container comprising:

a body assembly comprising a base and a continuous wall extending up from the base to define a top opening having an outer edge and an interior to hold the paintable liquid;

a gripping portion comprising a recess in the continuous wall and being sized, shaped, and positioned to permit a user to grip said gripping portion to hold said container; and

a wiping edge comprising a portion of the outer edge, the wiping edge being configured to be straight to facilitate wiping of a paint brush, and having a thickness greater than a thickness of the portion of the outer edge that is outside of the wiping edge.

According to yet another aspect of the present invention, there is provided a container for holding paintable liquid, the container comprising:

a body assembly comprising a base and a wall extending up from the base to define a top opening and an interior to hold the paintable liquid;

a gripping portion comprising at least one recess in the wall and being sized, shaped, and positioned to permit a user to grip said gripping portion to hold said container;

the wall of the body assembly expanding outwards from the base to the top opening, to facilitate stacking of another container inside the interior of the container; and

a stop located in the interior of the container, the stop being sized and shaped to maintain a minimum separation distance between the base of a first container and the base of a second container stacked inside the interior of the first container.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 is a perspective view of a paint container;

FIG. 2 is a see through view of FIG. 1;

FIG. 3A is a top view of the paint container of FIG. 1;

FIG. 3B is a side view of the paint container of FIG. 1;

FIG. 4 is a perspective view of three paint containers of FIG. 1 arranged in a stack;

FIG. 5 is a perspective view of the paint container of FIG. 1 showing a user's hand gripping the gripping portion and a paint brush inserted in the dipping section;

FIG. 6A is a perspective view of the paint container of FIG. 1 showing a paint brush being wiped on the leading edge of the tongue portion;

FIG. 6B is a view of the paint brush of FIG. 6A after it has been wiped;

FIG. 7A is a perspective view of the paint container of FIG. 1 showing a paint brush being dabbed on the tongue portion;

FIG. 7B is a view of the paint brush of FIG. 7A after it has been dabbed;

FIG. 8 is a perspective view of a portion of a paint container having a lip and ribs;

FIG. 9 is another perspective view of the paint container of FIG. 8;

FIG. 10 is a perspective view of an interior space of a paint container having a stop;

FIG. 11 is a perspective view of three paint containers of FIG. 10 arranged in a stack, with hidden elements shown in dashed line.

FIG. 12 is a perspective view of a paint container having an aperture in the shape of a circle;

FIG. 13 is a perspective view of a paint container having an aperture in the shape of a square;

FIG. 14 is a perspective view of a paint container having an aperture in the shape of a rectangle with curved ends and a notch;

FIG. 15 is a perspective view of a paint container having three apertures;

FIG. 16 is a perspective view of a paint container having three apertures at the back end;

FIG. 17 is a perspective view of a paint container having nine apertures;

FIG. 18A is a perspective view of four paint containers of FIG. 15 hanging from a common fixed object, with each paint container pointing in a different direction;

FIG. 18B is a diagram view of the four directions pointed to by the four paint containers of FIG. 19A;

FIG. 19A is a perspective view of a paint container having a tab extension with one aperture;

FIG. 19B is a perspective view of a paint container having a tab extension with three apertures;

FIG. 20 is a perspective view of the paint container of FIG. 12 hanging from the rung of a ladder by an S-hook connected to the aperture;

FIG. 21 is a perspective view of the hanging paint container of FIG. 20, showing a painter dipping a paint brush into the paint container;

FIGS. 22A and 22B are perspective views of a painter on a ladder painting with the paint container of FIG. 20;

FIG. 23 is a perspective view of the paint container of FIG. 16, resting on a step of a step ladder and attached to the step ladder by wire; and

FIG. 24 is a perspective view of a painter painting with the paint container of FIG. 15, where the paint container is hanging on a bar by a hook connected to a side aperture.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in commercially feasible embodiment are often not depicted in order to facilitate a less obstructed view of these various embodiments of the present disclosure.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, summary or the following detailed description. It is also to be understood that the specific devices and processes illustrated in the attached drawings, and described in the following specification, are simply exemplary embodiments (examples), aspects and/or concepts defined in the appended claims. Hence, specific dimensions and other physical characteristics relating to the embodiments disclosed herein are not to be considered as limiting, unless the claims expressly state otherwise. It is understood that “at least one” is equivalent to “a”.

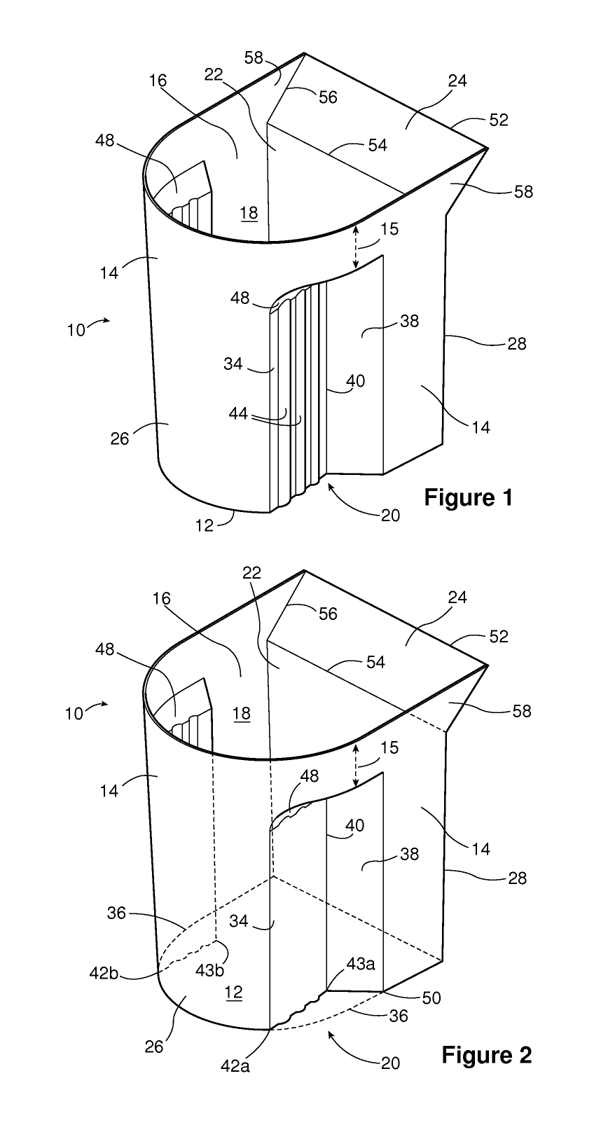

The paint container 10 is shown in FIG. 1. For additional clarity, a “transparent” version of the drawing of FIG. 1 is shown in FIG. 2. It can be seen that paint container 10 comprises a base 12 and a continuous wall 14 extending up from the base and forming a top opening 16. It can be appreciated that this structure defines a container volume 18 inside container 10 between base 12, continuous wall 14, and top opening 16. The container volume 18 may also be called an interior space.

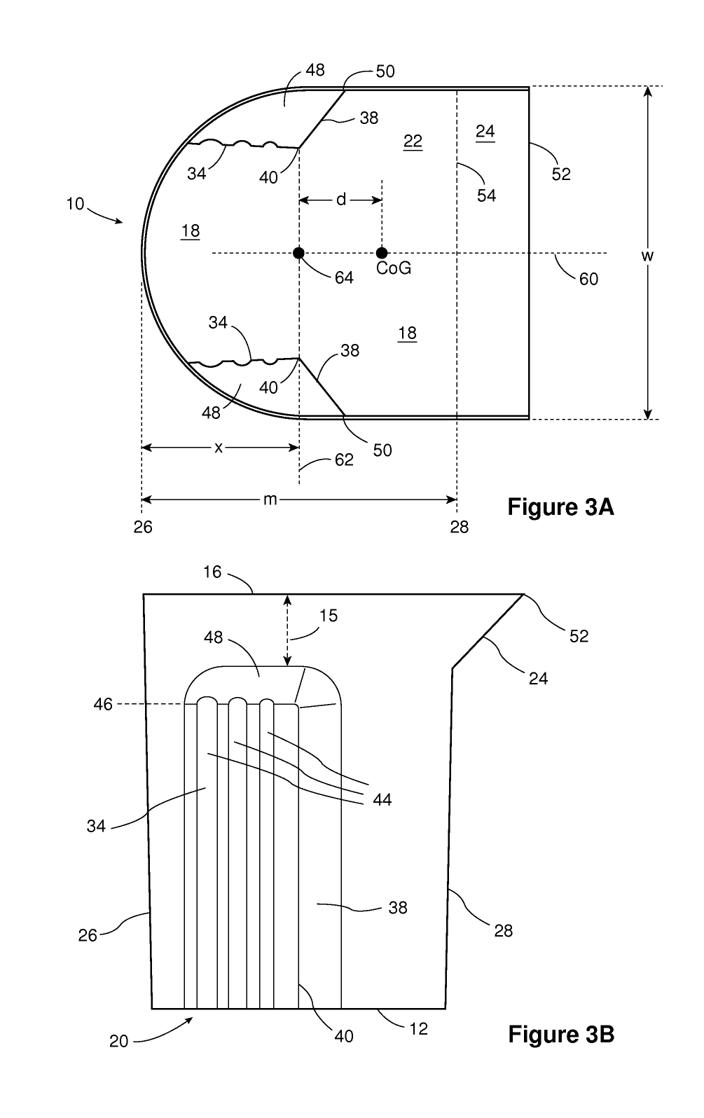

The paint container 10 further broadly comprises a gripping portion 20, a dipping section 22, and a tongue portion 24. For convenient reference, the container may be considered to have a first end or back 26 and a second end or front 28. As will be described in greater detail below, gripping portion 20 begins at back 26 and extends into the container. As shown in the top view of FIG. 3A, dipping section 22 is a portion of container volume 18 adjacent to front 28 or tongue portion 24. The tongue portion 24 extends outwardly and upwardly from the front or second end 28 of the continuous wall 14, adjacent to dipping section 22.

The paint container 10 is configured to hold a paintable liquid or paint 30, and to enable the paint to be dispensed onto a paint brush 32 for application on a surface by a painter. As discussed in greater detail below, container 10 also includes features that enable the user to hold the container in one hand, and to adjust the amount and distribution of paint on the brush.

In one embodiment continuous wall 14 is perpendicular to the base, and accordingly extends up to top opening 16 in a substantially vertical orientation. However, it is preferred that continuous wall 14 taper outwardly as the wall extends up from the base. In this way the width, length, and cross-sectional dimensions of top opening 16 at the top of container 10 will be larger than the corresponding dimensions of base 12 at the bottom of container 10. There may be any degree of outward taper, but adequate results may be achieved with an outward taper that is relatively small. For example, an outward taper of 0.103 inches for a vertical rise of 1 inch has been found to be adequate.

Extending continuous wall 14 with an outward taper is preferred because the outward taper enhances the ability of container 10 to be stackable. More particularly, continuous wall 14 and other features such as gripping portion 20 are preferably sized, shaped, and positioned to permit at least one of the instances of container 10 to be stacked inside another of the instances of container 10.

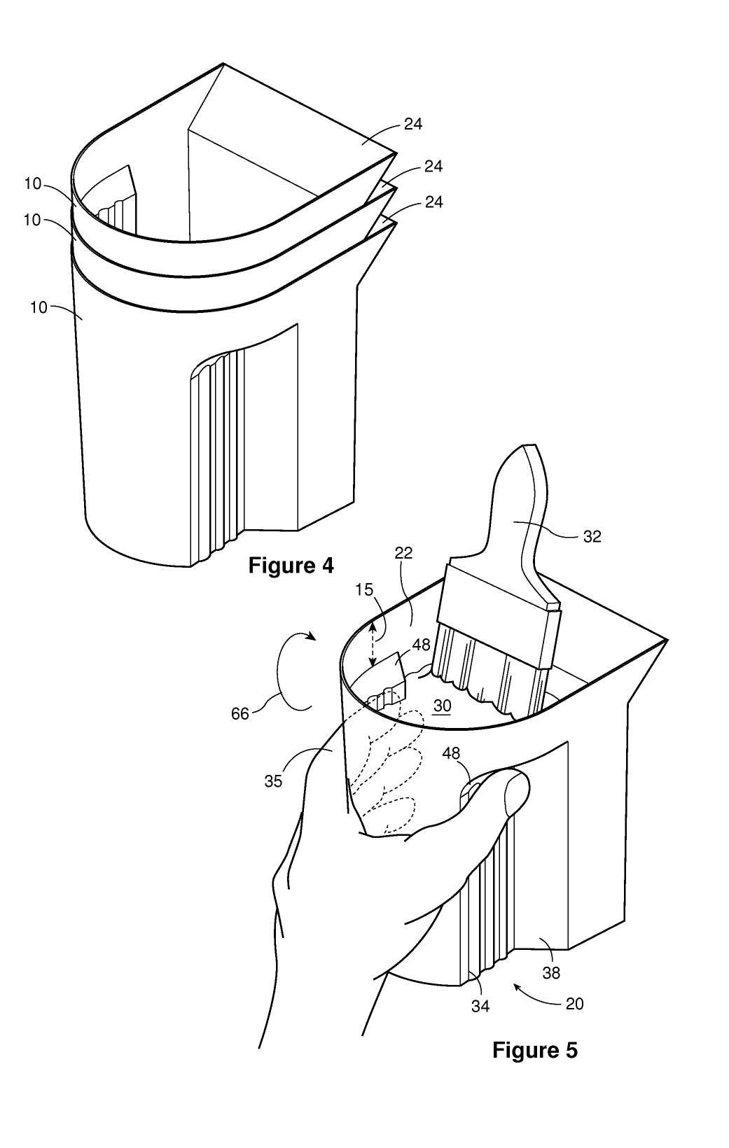

The stackable feature is illustrated in FIG. 4, which shows a group of three instances of container 10 arranged inside one another in a single stack. It can be appreciated that the stack arrangement greatly reduces the total space occupied by the constituent containers, in comparison to the space that the containers would otherwise occupy if they were separated and laid out side by side. Stackability of container 10 is accordingly a desired feature because it reduces the space required to transport and store multiple containers, and also reduces the shelf space needed to display the containers in a retail environment.

The gripping portion 20 is preferably formed in continuous wall 14, and is generally sized, shaped, and positioned to permit a user to grip, handle, or hold container 10. As will be discussed in greater detail below, gripping portion 20 comprises several elements of container 10.

The preferred embodiment of gripping portion 20 includes a recess 34 in continuous wall 14. For additional clarity, FIG. 2 shows dotted lines 36 to indicate the path that continuous wall 14 would have taken if not for recess 34. It can be seen that continuous wall 14 first breaks its path by following a side tapered section 38. In the embodiment shown recess 34 joins side tapered section 38 at a termination gripping portion 40, and then extends towards the back 26 of the container to gripping back edge 42a.

In FIG. 2, corresponding gripping back edge 42b on the other side of the container is shown, as well as corresponding gripping forward edges 43a and 43b which are situated at the bottom of termination gripping portion 40. It is preferred for the distance between 43a and 43b to be slightly less than the distance between 42a and 42b. In this way the gripping portion converges slightly along its length, which generally provides a more secure and comfortable grip.

It can be appreciated that other embodiments of recess 34 and side tapered section 38 are possible. For example, the transition between the sections may be more gradual, so that termination gripping portion 40 is less distinct and recess 34 and side tapered section 38 may be less distinguishable as separate elements. However, regardless of the particular embodiment, it can be appreciated that recess 34 represents a break or narrowing in continuous wall 14 of container 10 so that a smaller and more comfortable gripping surface is available to the user. A smaller gripping surface will be more likely to reduce the chance of the user experiencing hand strain when gripping container 10, and will generally be more comfortable.

It is also preferable that recess 34 include termination gripping portion 40 to provide a convenient point at which the user's thumb and fingers can receive support and rest against. The resting feature is a result of the user's digits naturally pressing or resting against the surface of the adjacent instance of side tapered section 38.

While the embodiment contemplates a gripping portion comprising a single instance of recess 34, more than one recess is also possible. An embodiment having two instances of recess 34, as shown in the figures, is preferred because a user's hand will grip the gripping portion in two places. In particular, where the gripping portion comprises first and second instances of recess 34 positioned in continuous wall 14, the first recess will preferably be spaced sufficiently apart from the second recess so as to permit the container 10 to be gripped by the placement of a thumb of the user's hand in the first recess and at least one finger of the user's hand in the second recess.

FIG. 5 shows this embodiment with a user's hand illustrated, the user's thumb gripping one instance of recess 34 and the other fingers gripping the other recess. In a further grip variation, instead of all four fingers gripping instances of recess 34, upper or index finger 35 may be raised above recess 34 and pressed against continuous wall 14, in particular at an upper portion 15 of continuous wall 14. In that case, the user's bottom three fingers would move up recess 34, so that the user's middle finger would be positioned at or near the top of recess 34.

Also as shown in the drawing, it is preferable for the user's palm to fit snugly against and have substantial contact with back 26 of container 10. For this reason, back 26 preferably has a curved profile, as shown in the figures.

The gripping portion 20 will preferably also include ridges 44 to facilitate gripping of gripping portion 20 by the user. The ridges 44 may be grooves embedded in the surface of recess 34, but other forms of ridges, or other grip enhancement features, are also contemplated. For example, pieces of material having grip enhancement properties may be glued or otherwise attached to a smooth surface such as recess 34 to provide similar benefits. The ridges 44 may also be formed on side tapered section 38, since the user's digits will preferably also rest against that surface.

As seen most clearly in the side view FIG. 3B, recess 34 extends upward from base 12 to an upper transition level 46. From there a portion of continuous wall 14 designated as upper tapered section 48 expands upwardly and outwardly until it reaches the outer part of container 10. This configuration is preferred because, as shown in FIG. 5, upper tapered section 48 provides a comfortable resting or support surface for the user's digits in an upward direction similar to the support and rest provided by side tapered section 38 in a forward direction. This preferred embodiment may alternatively be characterized as continuous wall 14 having a wall height, with at least one instance of recess 34 extending upwards from base 12 for a distance less than the wall height. It can be appreciated however that other embodiments are also comprehended, such as for example, extending recess 34 all the way up from base 12 to top opening 16.

It is to be appreciated that different users will choose to grip container 10 in different ways according to personal preference. However, it is believed that substantially every user will place their palm, thumb, and fingers against or in contact with back 26 and the two instances of recess 34. Accordingly, gripping portion 20 may be considered to include at least these elements. Further, gripping portion 20 also comprehends side tapered section 38, upper tapered section 48, and upper wall portion 15, since as noted some users will grip or maintain finger contact with container 10 at these places as well.

It is also preferred that recess 34 extend up from base 12, regardless of the eventual height of recess 34. This is because container 10 will not generally be stackable if there is any outward divergence at the bottom of the container. Accordingly, it is less preferred for there to be an outward tapered section at the bottom of the container, with recess 34 commencing some distance above base 12. Of course, if the stackable feature were not important in a particular application then such an embodiment might be more acceptable or preferred.

The dipping section 22 is preferably sized, shaped, and positioned to permit a brush to be inserted into dipping section 22 through top opening 16, to contact paint 30 contained inside.

As noted, dipping section 22 comprises a portion of the interior space or container volume 18 of container 10. In particular, dipping section 22 may be viewed as the portion of the contained volume that is not bounded by back 26 and the instances of recess 34. More particularly, and as shown in the top view of container 10 in FIG. 3A, dipping section 22 extends between termination gripping portions 40 and the front 28 of the container.

The dipping section 22 may be viewed as including side tapered section 38 followed by a longer section having a uniform width “w” adjacent to the front 28 of the container. In FIG. 3A, the dipping section is shown having the uniform width “w” between an intersection point 50, where side tapered section 38 meets continuous wall 14, and the front 28 of the container 10. If desired, dipping section 22 may alternatively be considered as comprising the uniform width section only. With reference to FIG. 3A, it is preferable that the distance from 40 to 50 be relatively short compared to the distance between 50 and 28.

The function of dipping section 22 is to provide a suitable interior space for a brush to be dipped. The embodiment comprehends that a brush may be inserted from anywhere along top opening 16 into container volume 18, including that portion bounded by back 26 and the instances of recess 34. However, it is expected that users will generally prefer to dip the brush in dipping section 22 because it is wider than that back portion, and accordingly easier to dip into, and also because it is closer to tongue portion 24.

It is also appreciated that brushes are available in many sizes, from tiny artist brushes to, more commonly, the three and four inch brushes used for painting building interiors and the like. To enhance the general flexibility and usefulness of container 10, and in particular with respect to use in building and large scale painting applications, it is comprehended that container 10 be preferably configured to accommodate at least three inch brushes, and preferably four inch brushes as well. As will be discussed in more detail below, this entails making tongue portion 24 have a width of at least three or four inches.

It is preferred that dipping section 22 have a dipping section width and the tongue portion have a tongue portion width, and that the dipping section width be substantially equal to the tongue portion width. The “dipping section width” is not meant to include side tapered section 38, regardless of whether side tapered section 38 is formally viewed as part of the dipping section. In FIG. 3A it can be seen that the dipping section and the tongue portion have the same width “w”. It is also comprehended that the dipping section width will be substantially equal to the tongue portion width if its average width, not including any side tapered section 38, is within the range of 85% to 115% of the tongue portion width. Therefore, rather than the dipping section have a completely uniform width, it may be designed to diverge or converge slightly, as long as the average width, not including a side tapered section 38, is within the above specified range. However, it is most preferred for the dipping section width to be equal to the tongue portion width, as shown in the drawings.

It is preferred for the width of the two sections to be close or preferably equal because such a configuration enhances dipping efficiency. Specifically, it enables a user to dip the brush into the dipping section, and then move the brush directly onto the tongue portion without having to re-orient the brush. This saves time and reduces or eliminates the need for the painter's wrist to turn or twist, as would be needed if the brush had to be re-oriented. It can be appreciated that painting is a very repetitive task, and that re-orientation of a brush, when repeated hundreds if not thousands of times, can lead to muscle strain and soreness, and even debilitating injury in some cases. Accordingly, it is preferred that the dipping section have the same width, or be within a close range, of the width of the tongue portion.

As can be seen in the figures, tongue portion 24 is inclined, and extends upwardly and outwardly from continuous wall 14 adjacent to dipping section 22. The tongue portion is also preferably sized, shaped, and positioned to permit a brush to be dabbed thereon to remove excess paint from the brush, and also to permit the excess paint to drain into the dipping section.

The tongue is inclined so that paint on the tongue's surface will be able to move by force of gravity back into the container. This feature of the invention is desirable because it helps keep the tongue relatively clean, so that it can be re-used effectively for dabbing purposes. The angle at which the tongue extends upwardly can vary as long as it is sufficient to permit paint to drain into the dipping section. However, the angle should also not be too high because that could make the tongue awkward to work with, particularly for dabbing brushes. It has been found that an inclination angle of approximately 45 degrees from the horizontal allows for both draining of excess paint and good workability, and accordingly this angle is preferred.

It can be seen from the figures that the preferred embodiment of the tongue portion is a rectangle. There is a leading edge 52, a bottom edge 54 where tongue portion 24 joins continuous wall 14 at front 28, and sides 56. Collectively, leading edge 52 and bottom edge 54 and sides 56 may be said to define a broad planar surface suitable for dabbing a paint brush. It can be appreciated that other embodiments are also possible, as long as the tongue functions to provide a surface for dabbing and an edge for wiping, and is inclined to permit paint to drain into the dipping section.

The leading edge 52 is preferably sized and shaped to provide at least one distinct edge or point suitable for wiping a paint brush. If the brush is positioned so that the side of the brush to be wiped is pressed against leading edge 52, and with the brush handle down and the bristles pointed up, as the brush is moved in a downward direction excess paint will be wiped off and be transferred to the surface of the tongue, from where it can drain into the dipping section. The user can increase the amount of paint drained by increasing pressure on the brush as it is being wiped. Brush wiping may also be performed along bottom edge 54, particularly as the brush is being removed from dipping section 22. However, in cases where container 10 is filled near capacity and the paint level is near that of bottom edge 54, it may be more convenient to wipe the opposing side of the brush along leading edge 52.

As noted, tongue portion 24 is also preferably sized and shaped to have a broad planar surface suitable for dabbing. In order to accommodate brushes of three or four inches in width, the tongue portion should be suitably wider, preferably about 3½ inches or 4½ inches respectively. The tongue portion should also have a length that is sufficiently long relative to the length of the brush being dabbed so that the full length of the brush can be dabbed without needing too many dabbing strokes.

It can be seen from the figures that sides 56 of tongue portion 24 are bounded by attached vertical portions or edge barriers 58. The edge barriers are useful in that they prevent excess paint on the tongue portion, particularly paint that is near the edge of sides 56, from spilling off the side. In the preferred embodiment shown, edge barriers 58 comprise an extension of continuous wall 14. It can be appreciated that other embodiments of the edge barriers may also be used, as long as they function to block spilling of paint off sides 56. It can also be appreciated that the tongue portion could be made without edge barriers. However, this configuration would not be preferred, since it could result in paint spilling off of the sides.

An embodiment of paint container 10 may now be described in greater detail. As a starting point, it is worth noting that small size retail paint containers generally contain about 900 ml of paint, and that this amount of paint weighs approximately in the range of 4 lbs. The amount of paint in 900 ml, or more broadly 800-1000 ml, is sufficiently large for most applications so that the container should last for a reasonable amount of time before replenishment is required. The 4 lb. weight will be familiar to most people since it is the common retail size. It can be appreciated that people who find 4 lbs. too heavy can simply avoid filling the container to capacity, and instead use as much paint as they can comfortably hold. Similarly, it can be appreciated that container 10 can be made in other embodiments that are scaled up or down in size, to hold more or less paint and be accordingly heavier or lighter, as desired.

It is also preferable for the paint container to be flexible enough to accommodate a wide variety of paint jobs, and accordingly to accommodate paint brushes having widths of at least 3 inches, and preferably 4 inches. It has been found that designing the container to have a tongue portion width of 4.5 inches is adequate to service a 4 inch paint brush. It can be appreciated again that the embodiment can be designed with larger or smaller tongue portions, as appropriate for individual situations.

It has been found that a paint container having the following additional dimensions provides adequate results. The container of the preferred embodiment has a height, from base 12 to top opening 16, of about 6.5 inches, and a thickness “t” of continuous wall 14 of about 1.65 mm.

With reference to FIG. 3A, at the base or bottom of the container the length “x” from back 26 to termination gripping portion 40 is 2 inches, and the length “m” from back 26 to front 28 is about 3.43 inches. At the top of the container, the length from back 26 to front 28 is about 4.03 inches.

At front 28 of the container, the width at the base or bottom is 3.93 inches, the width at the top of continuous wall 14 where it meets tongue bottom edge 54 is about 4.375 inches, and the width at tongue leading edge 52 is 4.6 inches. It can be appreciated therefore that in the preferred embodiment there is an outward taper of about 0.67 inches from base 12 to the top of the container, which represents an outward increment of about 0.103 inches for every 1 inch in vertical height.

The length of the tongue portion from bottom edge 54 to leading edge 52 is 1.25 inches, and the tongue is inclined upwards at 45 degrees from the horizontal. This results in a total length along the top of the container from back 26 to tongue leading edge 52 of about 5.05 inches.

The width of the gripping portion along the back 26, between 42a to 42b, is about 2.76 inches. This narrows down by about of an inch to the far end, between 43a and 43b, to approximately 2.65 inches.

An aspect of the preferred embodiment is that since the area bounded by the instances of recess 34 of gripping portion 20 is narrower than the dipping section, the center of gravity (“CoG”) of container 10 will frequently be located in the dipping section. This may cause a rotational torque about the gripping portion which will have the effect of tilting container 10 forward. As will be discussed below, this forward tilt can be beneficial to the user of paint container 10. However, the forward tilt should not be too large or it could be uncomfortable to the user.

FIG. 3A shows a center line 60 (shown as dotted) drawn through the center of container 10. The user's hands will grip the container at about termination gripping portion 40. This is represented as a dotted line 62, with a center point 64. The CoG is shown in the dipping section, at a distance “d” from center point 64. In the circumstances shown, a rotational torque or moment will be produced about the gripping portion equal to the weight of the container and its contents multiplied by the distance “d”. The effect of the torque will be to tilt the container forward, in the sense that tongue portion 24 will be urged downward, and base 12 at back 26 will be urged upward. This torque factor is represented by curved arrow 66 in FIG. 5.

It has been found that in general, designing container 10 so that the length “x” of the gripping portion is preferably at least 40%, more preferably at least 45%, and most preferably at least 50% of the length “m” of base 12 will provide a reasonably low torque value that will be comfortable to most users. It can be appreciated that if the container is made larger, for example, to hold more paint, the torque will increase because the weight of a full container through the CoG will increase. This would suggest extending the length of the gripping portion towards or past 50% would be desirable. Conversely, for a smaller container a shorter grip portion may be adequate.

More broadly, where the container has a center of gravity positioned between the instances of recess 34 of gripping portion 20 and the tongue portion, so that a torque is created about the gripping portion when the container is held by a user at the gripping portion, the container is preferably sized and shaped to limit the torque to no more than one foot-pound, more preferably 0.8 foot-pounds, and most preferably 0.6 foot-pounds, when the container is full of paintable liquid.

It can now also be appreciated that if the recessed grip portion is made narrower or wider it will change the distribution of volume of the container, which will have an effect on the resulting torque. In particular, if the recessed grip portion between 42a and 42b, and between 43a and 43b, is made narrower, the CoG will move farther away, towards front 28, which will increase “d”. On the other hand, the overall capacity of the container may decline because the volume of the gripping portion is smaller, so that the weight at the CoG may be somewhat less. Therefore, the distribution of volume within the container is optimized to a predetermined agreeable level of torque, which may in turn help to determine the appropriate width of the recessed gripping portion.

Similarly, if the container is scaled larger the weight at the CoG will increase, which will increase the torque. It may then be preferable to reduce the length of the dipping section while increasing the height of the container, so that the torque will remain within the preferred range and not be too high so as to be uncomfortable to a user. It is preferable for the container 10 to remain within the preferred torque range regardless of the size or volume capacity of the particular embodiment of the container.

The paint container 10 is preferably made from plastic due to that material's light weight and strength, low cost, compatibility with paintable liquids, and ease of manufacturing. In particular, “co-polymer polypropylene” plastic has been found to provide adequate results, as it is relatively strong, durable, and low cost. This embodiment of container 10 can be made using standard plastic manufacturing techniques such as injection moulding. It can be appreciated that other materials, such as stainless steel, aluminium and other metals, may also be used if they have some or all of the functional benefits of plastic. In some cases a higher cost material might be preferred if it offers certain benefits, such as being more durable or easier to clean than plastic, for example.

As discussed above, tongue portion 24 includes leading edge 52 for brush wiping, and a broad planar surface for brush dabbing. It is to be appreciated that these functions are best or optimally provided to a user of container 10 when leading edge 52 forms a straight, clean line or edge throughout it's length “w”, and similarly, when the broad planar surface of tongue portion 24 maintains a flat and uniform profile throughout its area. Several factors however may cause some distortion or interruption to the ideal contour of these elements.

The plastic injection moulding process that is commonly used to produce container 10 involves liquefying a plastic raw material and forcing it into a mould cavity at high temperature and pressure. Upon cooling and hardening, the resulting plastic object, container 10, is ejected from the mould. In modern high speed machines this process may be repeated several times a minute. As a by-product or artifact of this process, it sometimes develops that long, thin edges in the plastic object being produced, such as tongue leading edge 52 of container 10, emerge from the mould with a noticeable and undesirable curve, bend, or “crown”.

Another factor that may lead to deformation of tongue portion 24 relates to the general manner in which painting and construction tools are handled and stored in the course of daily trade. Whether deliberately or carelessly, container 10 is subject to being thrown or knocked about, and/or packed or stored underneath much heavier objects. For example, at the end of the day or upon completion of a paint job, container 10 may be thrown into a garage, shed, or back of a truck, where it may be squeezed or crushed under the weight of much heavier equipment such as ladders, workbenches, mechanical tools, and the like. Further, container 10 may be left bearing this weight for extended periods of time, possibly even for as long as months or years in some cases. In this way, leading edge 52 and the broad surface area of tongue portion 24 may become bent, chipped, or broken, so that the utility of container 10 is compromised.

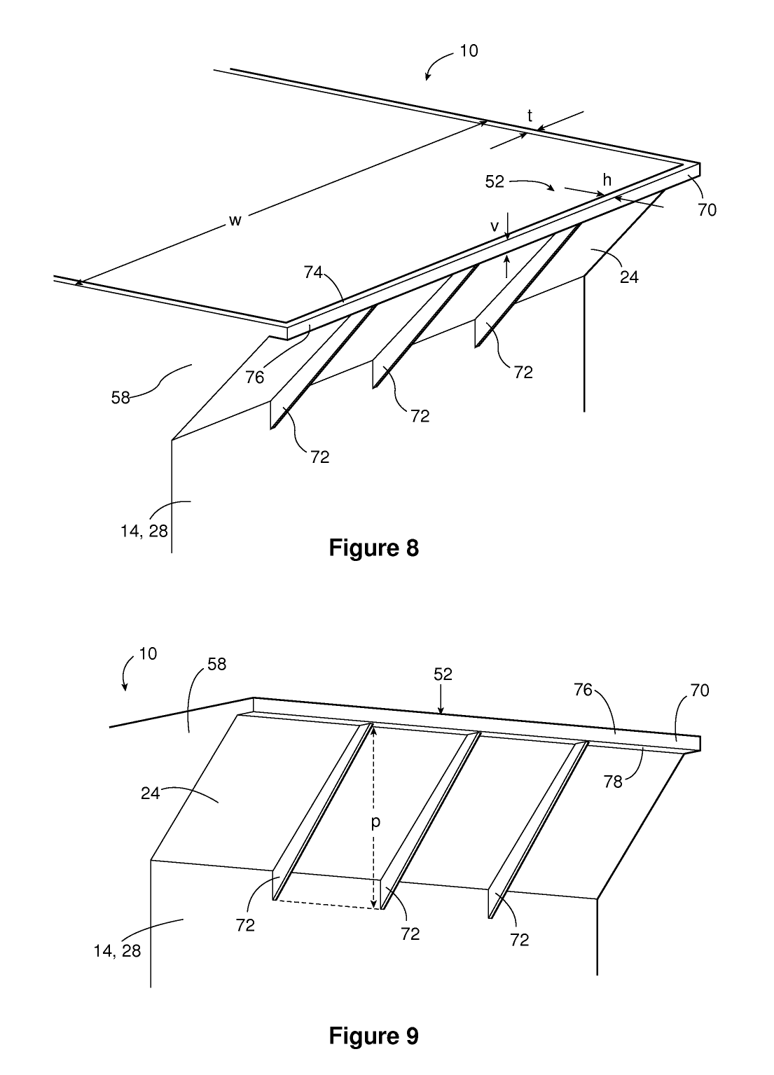

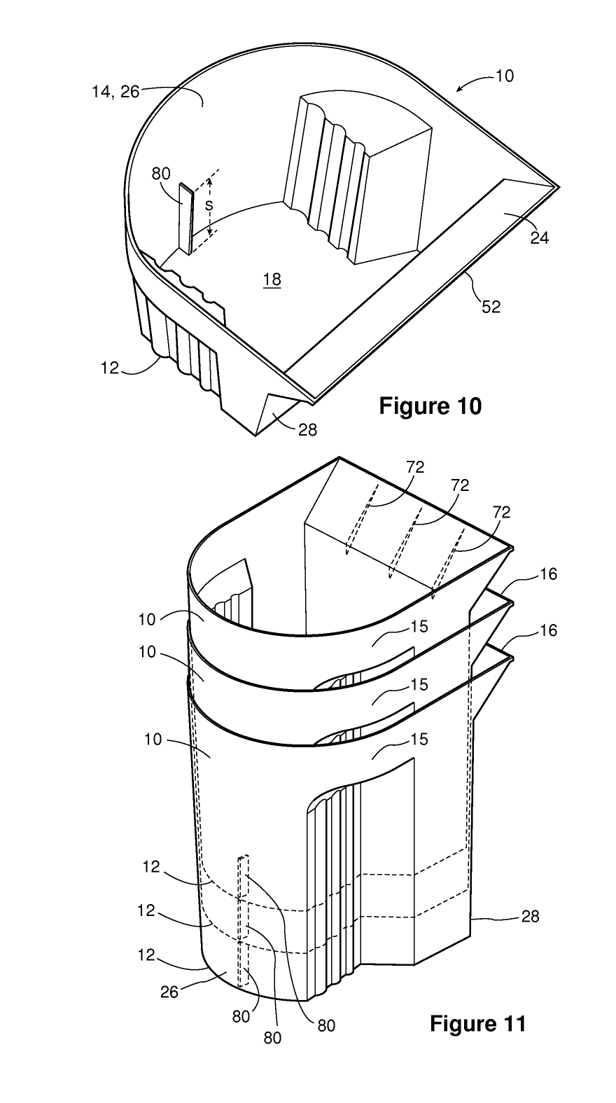

These risks to the structural integrity of tongue portion 24 may be addressed by providing additional reinforcement and support to container 10. According to some embodiments of the invention, and as shown in FIGS. 8 and 9, container 10 may be constructed with a lip 70 and one or more ribs 72. As indicated, three ribs 72 may be used according to some embodiments of the invention.

The lip and ribs reinforce and buttress tongue portion 24 and leading edge 52, so that these latter two elements have increased mechanical strength. More particularly, it has been found that lip 70 substantially reduces or eliminates the risk of crowning of leading edge 52 that may occur during production of container 10 by plastic injection moulding. Further, the combination of lip 70 and ribs 72 act to strengthen tongue portion 24 so that it is less likely to be chipped, bent, deformed, or warped when subject to rough handling or pressure from a heavy load.

Turning now to FIGS. 8 and 9, lip 70 adds a measurable degree of thickness and solidity to tongue leading edge 52. More particularly, lip 70 comprises an upper surface 74 that extends leading edge 52 in the horizontal plane, and a vertical surface 76 that extends leading edge 52 in the vertical plane. According to some embodiments of the invention, lip 70 may have an upper surface thickness “h” of about 2.6 mm, and a vertical surface thickness “v” of about 3 mm. These dimensions have been found to be adequate in substantially reducing or eliminating the risk of crowning of leading edge 52 by the injection moulding production process. More broadly, upper surface thickness “h” may be in the range of 2.2 to 3.0 mm, and the vertical surface thickness “v” may be in the range of 2.6 to 3.4 mm.

As noted above, the thickness of continuous wall 14 of container 10, shown as “t” in FIG. 8, is 1.65 mm in some embodiments. In order to provide additional reinforcement and rigidity to tongue portion 24, it is preferable that upper surface thickness “h” and vertical surface thickness “v” each be somewhat thicker than wall thickness “t”, or at least no less than the same as wall thickness “t”. As noted, at 2.6 mm and 3 mm respectively, surface thicknesses “h” and “v” are both larger than wall thickness “t” in the embodiment described above. Both dimensions “h” and “v” may be made larger if greater protection is desired, and/or if a version of container 10 is made that is substantially larger than the preferred embodiment.

According to an option, container 10 may be viewed as having an outer edge that is defined by top opening 16 and that extends around the upper periphery of the container, to include back end 26, front end 28, and the sides of the container. The thickness of the outer edge is “t” at back end 26 and sides of the container, and is “h” at front end 28, corresponding to tongue leading edge 52. The portion of the outer edge having thickness “h” may be called a wiping edge. The thickness or width of “h” is greater than the thickness or width of “t”.

Ribs 72 are shown in perspective view in FIGS. 8 and 9. As indicated, each instance of rib 72 is in the form of a four-sided plane, with three of the sides attaching to three surfaces of container 10, specifically a bottom surface 78 of lip 70, an outside surface of tongue portion 24, and the top of continuous wall 14 on the front side 28 of the container. It is to be appreciated that since each instance of rib 72 is anchored to a surface on either side of tongue portion 24, ribs 72 provide effective support and reinforcement for tongue portion 24.

The three ribs 72 are spaced approximately equidistant from one another and from edge barriers 58 of container 10. According to an option, this distance is about 1.12 inches (28.5 mm). Further, as shown in FIG. 9 by distance “p”, in an embodiment each instance of rib 72 has a vertical projection on container 10 of about 1.3 inches (28.2 mm).

The thickness of each rib 72 is preferably about 1-1.5 mm. More particularly, in injection moulding plastic technology it is often preferable for elements to taper along their length. As a result, according to some embodiments ribs 72 may be about 1.44 mm thick at their base, or where they attach to continuous wall 14, and taper to a thickness of about 1.41 mm where they attach to bottom surface 78 of lip 70. Unlike lip 70, it is preferable that ribs 72 be thinner than thickness “t” of continuous wall 14, as ribs that are thicker than “t” may lead to a downward sag of tongue portion 24.

It is to be appreciated that lip 70 and ribs 72 do not interfere with the brush dabbing and wiping utility of tongue portion 24. Neither element covers any part of the inner, broad surface area of tongue portion 24 that is used for dabbing. With respect to brush wiping, the brush may be wiped against the inner or outer edge of lip 70 by adjusting the brush handle orientation upwards or downwards, respectively. Wiping may also be performed across upper lip surface 74, which while thicker than either edge, is still very narrow relative to the side of a brush and accordingly still provides an effective edge for wiping.

As discussed above, container 10 is configured to be stackable. However, when items such as container 10 are stacked, there is a risk that one or more of them may become stuck or otherwise difficult to dislodge from the stack. This is undesirable in a retail environment, since it could lead to frustrated customers and lost sales.

This problem may occur due to the presence of excess friction between adjacent containers, particularly if a container has been jammed into the stack with a greater force than necessary. Such action may be inadvertent, and might occur, for example, by a production worker hurriedly packing boxes for shipping, or by a retail clerk seeking to fit more items into a single stack to maximize shelf space.

Another factor that may cause adjacent stacked containers to stick relates to the design of container 10. As described above, gripping portion 20 is effectively formed from a “hollowed-out space” defined by recess 34, side tapered section 38, and upper tapered section 48 on opposing sides of the container. Also as noted, upper wall portion 15 is a part of continuous wall 14 that is between the top of upper tapered section 48 and top opening 16. In the figures upper wall portion 15 is shown as a dashed arrow to represent its fixed or specific height at its highest point, which is about 1.3 inches in the preferred embodiment. As a result of this configuration, and as shown in FIG. 4, when adjacent instances of container 10 are placed on top of one another in a stack, the top of upper wall portion 15 of the lower container may overlap with the bottom of upper wall portion 15 of the adjacent upper container. In such a case the hollowed-out space in the upper container may become enclosed on all sides and form a type of vacuum effect that acts to resist separation of the two adjacent containers. It is also to be appreciated that any such vacuum effect resistance would be generally cumulative or additional to any separation resistance that may already be present due to excess friction between the containers.

According to some embodiments of the invention, and as shown in FIG. 10, the problem of stuck or difficult to remove containers in a stack may be substantially reduced or eliminated by including a stop 80 positioned in container 10. The stop 80 may also be called a block or a spacer. Stop 80 in a lower container prevents or blocks another, upper container inserted into container volume 18 from descending any further than a minimum separation distance or height “s” above base 12 of the lower container. As will be explained in greater detail below, according to some embodiments “s” may be 1.5 inches (38.1 mm).

Stop 80 may be conveniently implemented, according to some embodiments, by positioning a rigid element in container volume 18 so that its upper surface is at a distance “s” above base 12. As shown in FIG. 10, stop 80 may be a rectangular tab or panel that is attached to the juncture of base 12 and continuous wall 14, at the back 26 of container 10. For a height “s” of 1.5 inches, stop 80 extends outward from continuous wall 14 by about 5 mm. This length has been found to be adequate since stop 80 only needs to catch an edge of base 12 to effectively block further penetration of the upper container. The thickness of stop 80 at its base, where it attaches to base 12, may be about 1.4 mm, with a taper to about 0.8 mm at the top, or distance “s” above base 12. Stop 80 may be made longer and/or wider if a more robust element is desired.

Stop 80 may be attached to continuous wall 14 at any point but is preferably attached to back 26, since placement at front 28 would put it in dipping section 22 where it could interfere with a brush being dipped by a user. More than one instance of stop 80 may be used in container 10, but it has been found that a single instance of stop 80 may be adequate.

It is to be appreciated that since stop 80 physically limits the distance that an upper container can penetrate into a lower container, the stacked containers cannot be forced, pushed, or jammed together any closer than the minimum separation distance “s”, regardless of whether the person doing the pushing is acting deliberately or inadvertently.

Further, it may be noted that when the containers are positioned at the minimum separation distance “s”, there will be maximum contact between adjacent sections or portions of continuous wall 14 and a corresponding maximum amount of stickiness due to friction. Accordingly, when designing stop 80, the distance “s” may be selected to be large enough so that the expected maximum amount of frictional contact at that separation distance is generally acceptable, i.e. one that allows the adjacent containers to be separated relatively easily and without too much difficulty.

Stop 80 is also configured to substantially remove the risk of separation resistance due to trapped air in the hollowed-out space of gripping portion 20. This may be accomplished by sizing the separation distance “s” to be at least slightly larger than the distance represented by upper wall portion 15. When configured in this way, adjacent stacked containers will be separated by a distance greater than upper wall portion 15, the instances of upper wall portion 15 of the two containers will not overlap, and there will always be an opening permitting air to enter the hollowed-out space of the instance of the upper container. Accordingly, air will not be trapped between the stacked containers, and that source of separation resistance is eliminated.

FIG. 11 illustrates this aspect of the invention by showing a stack of three instances of container 10, with hidden elements represented by dashed lines. It may be seen that base 12 of the middle container rests on stop 80 of the bottom container, and base 12 of the top container rests on stop 80 of the middle container. Since the height of each stop 80 is separation distance “s”, or 1.5 inches, which is greater than upper wall portion distance 15 of 1.3 inches, the instances of upper wall portion 15 of the top and middle containers are each above top opening 16 of their corresponding lower containers. As shown, there is an opening into the hollowed-out spaces of the top and middle containers, just below the instances of upper wall portion 15, so air cannot be trapped and form a vacuum effect in these containers.

Yet another consideration in the design of stackable instances of container 10 is to ensure that ribs 72 of the upper container do not contact or interfere with any part of the lower container. This may be achieved by selecting separation distance “s” to be at least slightly larger than vertical projection distance “p”. In the preferred embodiment “s” is 1.5 inches, which is larger than “p” of 1.3 inches. As a result, as shown in FIG. 11, ribs 72 of the upper container (shown by dashed lines) do not contact the middle container.

Having a stop 80 to prevent adjacent containers in a stack from sticking is particularly useful for containers having a ratio of height to top opening length or width that is greater than one, because in such configurations the adjacent containers have a relatively large amount of frictional contact. As noted, the preferred embodiment of container 10 has a height of 6.5 inches, a length at top opening 16 of 5.05 inches, and width “w” of 4.6 inches. Accordingly, for container 10 the ratio of height to top opening length is 6.5/5.05=1.29, and height to top opening width is 6.5/4.6=1.41, both of which are greater than one.

It is to be appreciated that injection moulding production technology may be employed to enhance a variety of aspects of container 10. For example, the mould may be adapted to provide a course texture on all or part of gripping portion 20. A course texture is beneficial because it enables a user to maintain a more secure grip on container 10, particularly when the user's hand or the container is wet. Preferably the course texture would be applied to all parts of the hollowed-out space, i.e. the instances of recess 34, side tapered section 38, and upper tapered section 48.

Another enhancement is to adapt the mould to round off any sharp edges, both on the outside of the container and in container volume 18 (interior space). This has the benefit of making the surfaces of container volume 18 easier to clean, and also provides a generally more attractive look and feel to container 10.

According to an option, the container 10 is for use with paintable liquid 30, a fixed or stationary object 82, and a connector 86. The container 10 includes (and is not limited to): a wall 14 and a connector receiver 84. The wall 14 may be called or may be a continuous wall. The wall 14 is configured to surround the paintable liquid. The connector receiver 84 is provided by (such as, is defined by) the wall 14. The connector receiver 84 is configured to receive the connector 86 once the connector 86 is positioned to do just so. The connector 86 is configured to connect the connector receiver 84 to the fixed object 82. Once the connector 86 connects the connector receiver 84 to the fixed object 82, the paintable liquid 30 remains surrounded by the wall 14 and remains within the container 10.

More particularly, while gripping portion 20 enables a user to conveniently hold container 10 in one hand, in many painting situations it is desirable or convenient to suspend or hang container 10 from a fixed or stationary object 82 (such as a surface). For this purpose, according to some embodiments of the invention and as discussed above, container 10 may be configured to include the connector receiver 84. The availability of connector receiver 84 enables a user to take a separate instance of connector 86, and connect or attach one end of connector 86 to connector receiver 84 of container 10, and similarly attach an opposing end to fixed object 82 (fixed surface).

Some examples of fixed object 82 (such as, a fixed surface) that may be used by painters include a side-rail or rung of a ladder, a pipe, beam, fence, hook, ring, ledge, or edge of a counter or table. Connector 86 may be any type of tool, accessory, or implement commonly used by painters and tradespeople, including for example such items as an S-hook, pot hook, flexible wire such as electrical or tie wire, and even a bendable wire coat hanger. When flexible wire is used as connector 86, a sufficient length of wire will typically be passed or threaded through connector receiver 84 so that the passed wire may be bent back and wrapped or tied to itself, or to fixed object 82 (fixed surface), to form a secure connection.

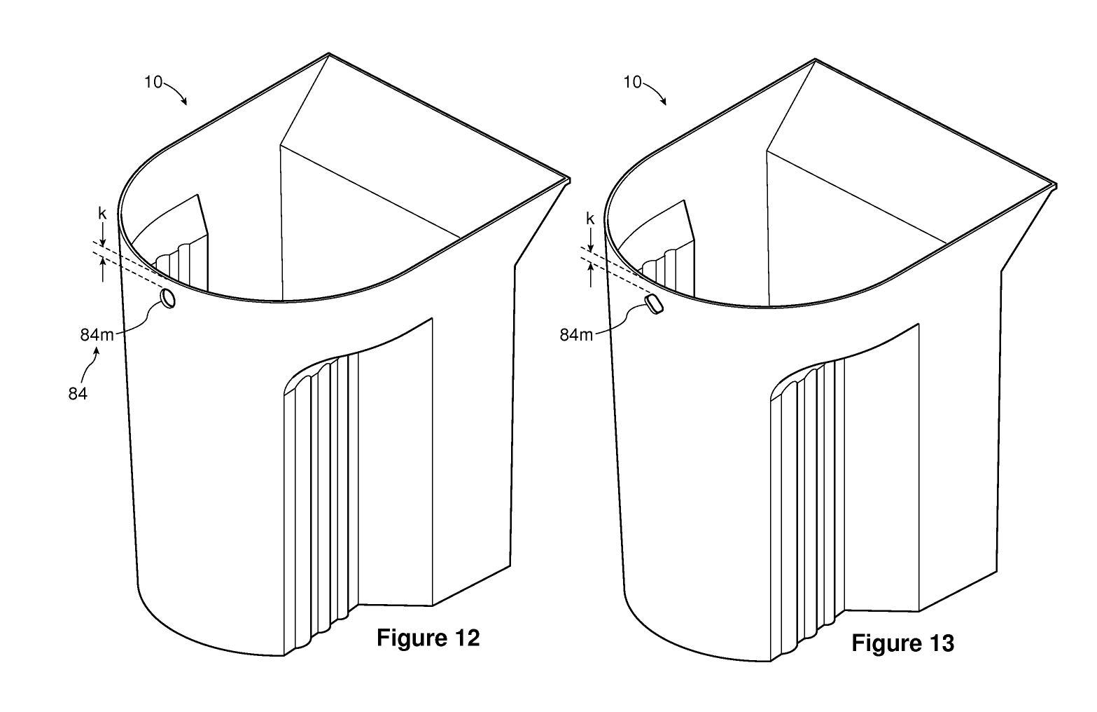

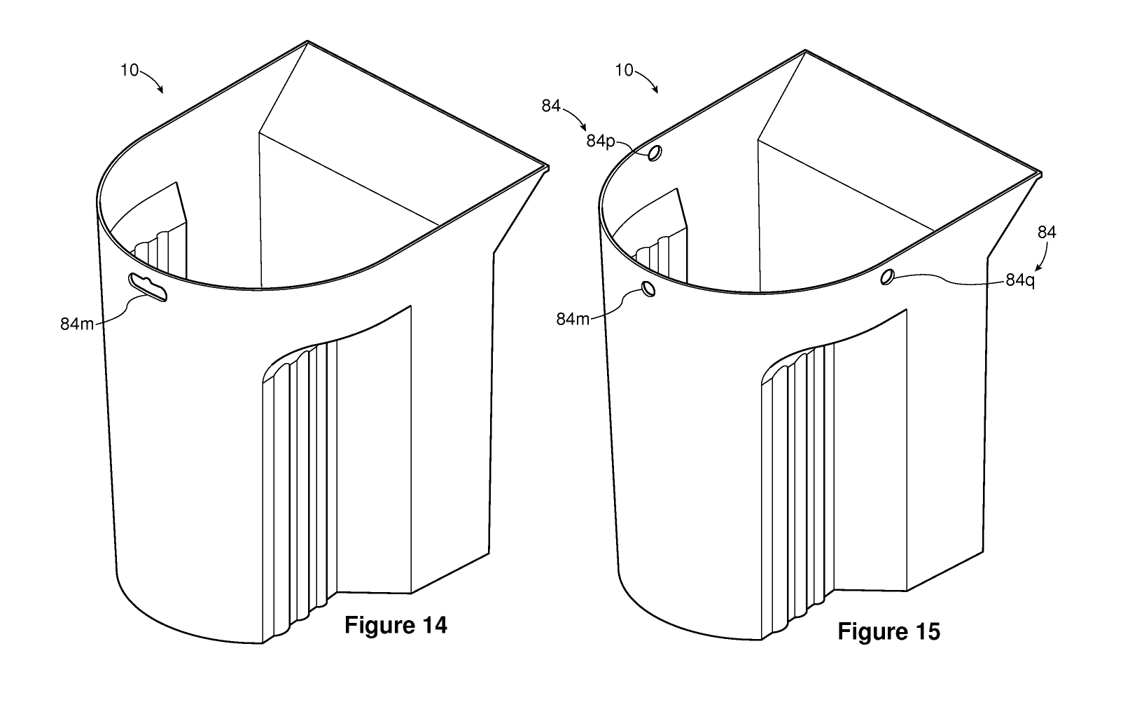

Connector receiver 84 is preferably in the form of an aperture or hole positioned within or defined by continuous wall 14. As shown in the figures, connector receiver 84 includes an aperture defined by continuous wall 14, and the apertures may be configured in a variety of shapes, forms, and/or sizes (as may be required or desired). For example, FIG. 12 shows connector receiver 84m (embodied as the aperture) as a hole in the shape of a circle, FIG. 13 shows connector receiver 84m (embodied as the aperture) shaped as a square rotated 45 degrees from the horizontal, and in FIG. 14 connector receiver 84m (embodied as the aperture) is shaped as a rectangle with rounded sides and an upward pointing notch in the middle of the top side. It is to be appreciated that many other shapes and forms of connector receiver 84 are possible, as long as connector receiver 84 is sized and shaped to interface (receive or slidably receive) connector 86. For the circular shaped aperture, it has been found that a diameter in the range of about 14/64 to 18/64 of an inch, for example, one-quarter (¼) inch (about 6.35 mm), is adequate to receive most commonly used hooks as well as wire. For other aperture shapes, having an internal opening in this dimension range is adequate.

Preferably, and as shown in the figures, connector receiver 84 (aperture) is shaped so that the uppermost point of the aperture is either rounded or a vertex, i.e the intersection of two sides. In this way, the contact surface of connector 86 will naturally settle into the uppermost point where it will be relatively fixed in place and resistant to sliding from side to side inside connector receiver 84 (aperture).

According to an option, connector receiver 84 may be positioned at or near the top of continuous wall 14, substantially adjacent to top opening 16. In this way connector receiver 84 (aperture) is safely above tongue bottom edge 54, which as discussed below is the highest level to which paint will likely be filled in container 10. Further, when connected at this high position the downward tilt or angle which container 10 would assume when freely suspended would be relatively low. This is advantageous because the maximum amount of paint that can be held in container 10 without paint spilling out is reduced as the tilt angle increases.

However, it is also to be appreciated that connector receiver 84 (aperture) should not be positioned too high, as there should be sufficient distance “k” between the uppermost point of connector receiver 84 (aperture) and the top or upper edge of continuous wall 14 so that the structural integrity of continuous wall 14 immediately above and in the vicinity of connector receiver 84 (aperture) is not compromised. If distance “k” is too small there is a risk of a break in continuous wall 14, particularly when container 10 is substantially full of paint and accordingly relatively heavy in weight. Distance “k” may be reduced to some extent as the strength of the material from which container 10 is made increases. It has been found that for the plastic materials commonly used, a minimum distance “k” of about 4 mm is adequate, with 4.5 mm providing an extra margin of safety.

According to an option, at least one connector receiver 84m (aperture) is positioned at the middle of back end 26 of container 10. This is the position of the single instance of connector receiver 84m shown in FIGS. 12, 13, and 14. When connector 86 is attached to (slidably received by) connector receiver 84m in this position, container 10 may be suspended in a manner that is balanced and symmetric about center line 60 (shown in FIG. 3A), which minimizes the risk of spilling paint and is generally more comfortable for the user.

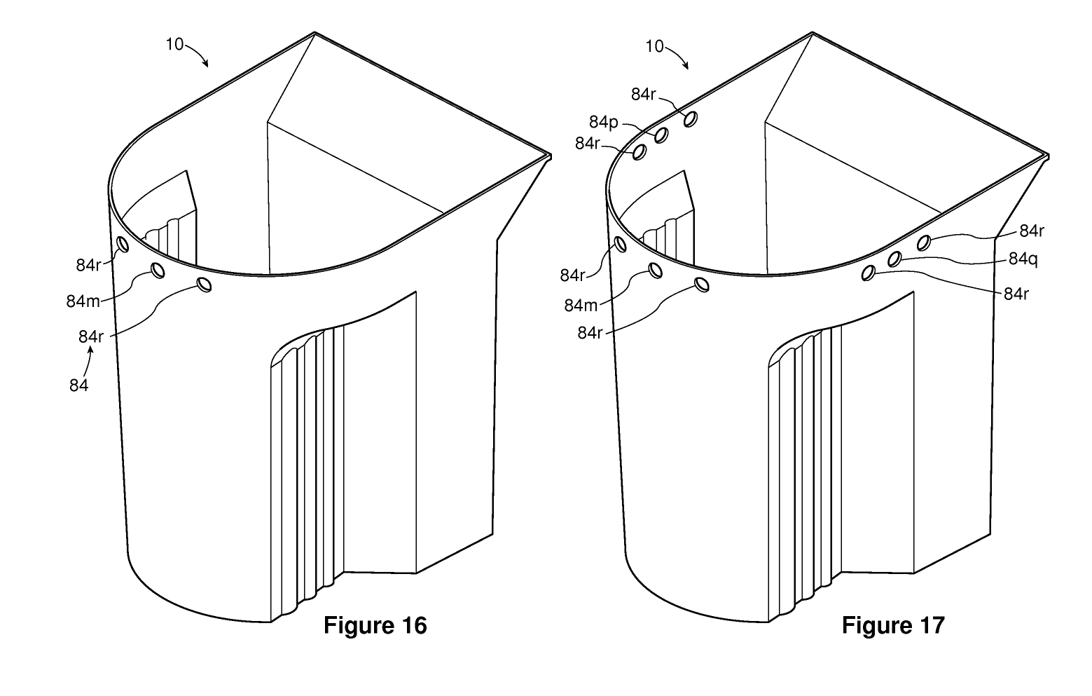

As indicated in the figures, according to some embodiments of the invention container 10 may include additional instances of connector receiver 84 (aperture). FIG. 15 shows additional instances of side aperture 84p and side aperture 84q located in opposing sides of container 10, and FIG. 16 shows an instance of a pair of outer apertures 84r. Each pair of outer apertures 84r flank a central aperture, such as aperture 84m as shown in FIG. 16, such that one outer aperture 84r is on one side of the central aperture and the other outer aperture 84r is on the other side of the central aperture. According to an option, the distances from each outer aperture 84r to the central aperture are the same. FIG. 17 shows an embodiment of container 10 containing three apertures at each of back end 26 and both sides of the container, for a total of nine apertures. More particularly, in FIG. 17 there are three central apertures 84m, 84p, and 84q, each of which has an accompanying outer aperture 84r pair.

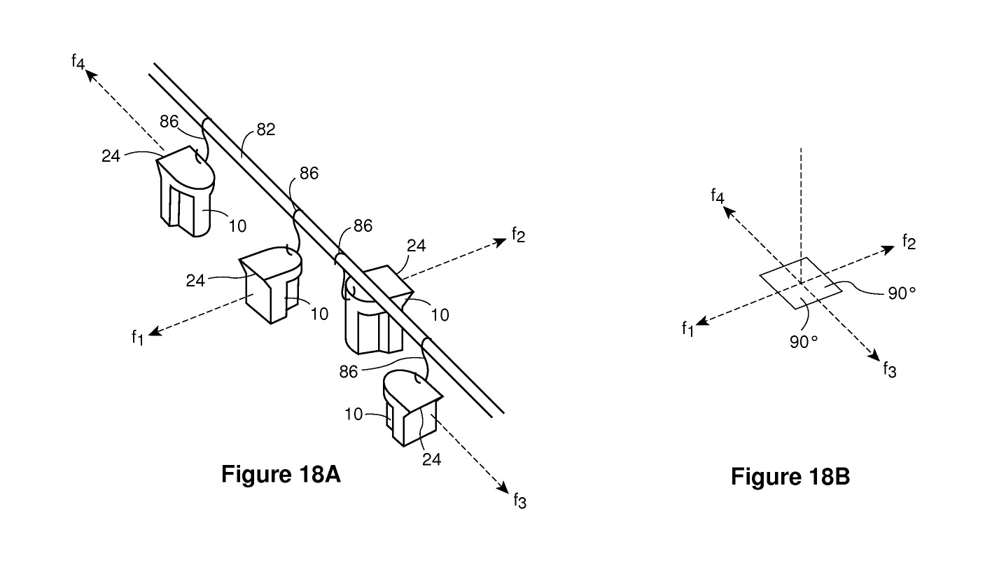

The embodiments of FIGS. 15 and 17, with instances of connector receiver 84 (aperture) positioned or located on opposing sides of container 10, provides improved flexibility in orienting the suspended container 10. More particularly, it is to be appreciated that when suspending container 10 from connector receiver 84m positioned in the middle of back end 26, tongue portion 24 may be oriented to face in either of two opposing (180 degrees apart) directions f1 and f2, depending on the orientation of connector 86 (hook) on fixed object 82, as shown in FIG. 18A. Further, through attachment to instances of side aperture 84p and side aperture 84q, tongue portion 24 may be oriented in either of two opposing (180 degrees apart) directions f3 and f4, that are each orthogonal to the line set by directions f1 and f2. A graphic representation of the four directions f1, f2, f3, and f4, and their relationship to one another is shown in FIG. 18B. Accordingly, according to some embodiments, container 10 may be suspended and selectively oriented to face in any of four mutually orthogonal positions.

The embodiments of FIGS. 16 and 17, with additional instances of outer aperture pair 84r positioned on either side of central apertures 84m, 84p, and 84q, provide flexibility when using connector 86, including a wire connector. More particularly, connector 86 (wire connector) may be laced or threaded through the pair outer apertures 84r rather than through the central apertures 84m, 84p, and 84q. It is to be appreciated that attachment through two points of contact rather than one will generally provide greater stability and strength to the connection with fixed object 82. Further, in this arrangement connector 86 (wire connector) is horizontally oriented, which will generally allow for more convenient attachment to a vertically oriented instance of fixed object 82 (fixed surface). Where fixed object 82 (fixed surface) is horizontally oriented, it may be more convenient to attach connector 86 (wire connector) through the central apertures 84m, 84p, and 84q. Some examples of the situations or applications in which the additional apertures of FIGS. 15, 16, and 17 are useful are discussed further below.

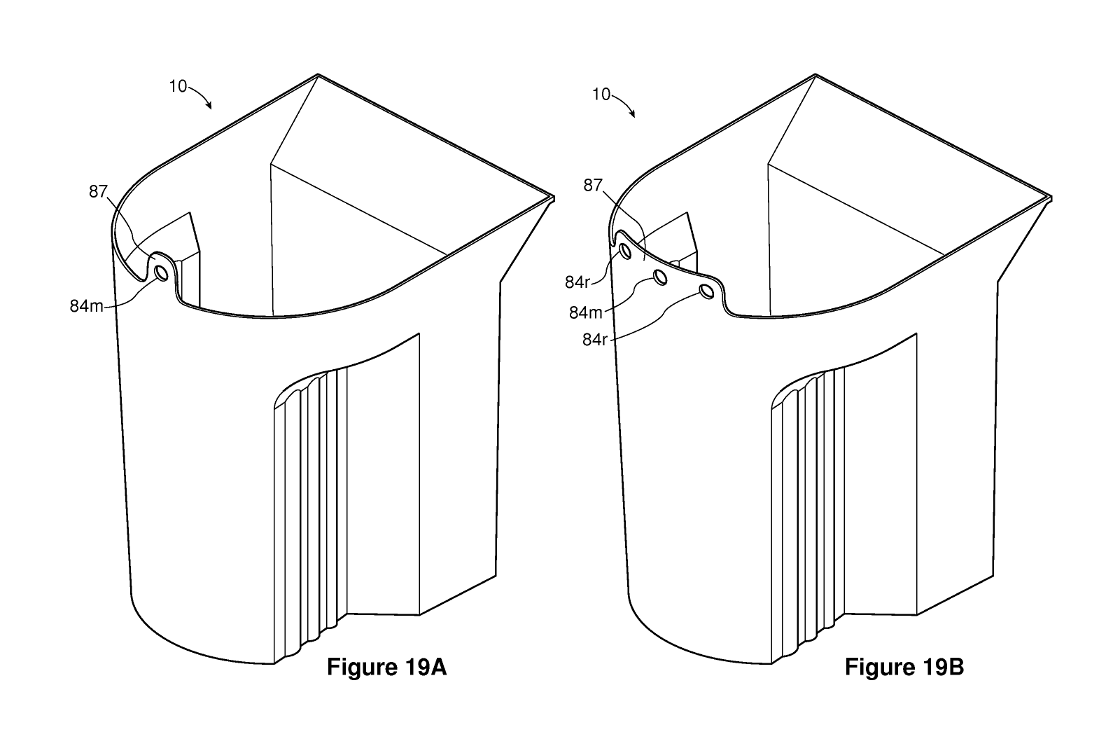

According to an option and as shown in FIGS. 19A and 19B, container 10 may be configured to include an extension tab 87. The extension tab 87 is a portion of continuous wall 14 that extends beyond top opening 16. According to an option, extension tab 87 may define an outer peripheral edge of instances of connector receiver 84, such as aperture 84m (FIG. 19A), or aperture 84m and outer aperture pair 84r (FIG. 19B). Accordingly, extension tab 87 may be sized and shaped to accommodate the number, size, and shape of connector receivers desired. Extension tab 87 may be positioned at back end 26 and/or at either or both sides of container 10. According to an option, extension tab 87 extends in a generally vertical direction from continuous wall 14, such as coplanar with continuous wall 14 as shown in the figures. According to an option, extension tab 87 may be configured to bend away from the vertical, either in a backward direction (away from front end 28) or in a forward direction (towards front end 28).

The operation and/or use of container 10 can now be described. The user will begin by selecting a paintable liquid appropriate for the project. While painting a building using latex or oil based paint is most common, other paintable liquids such as varnish or stain, such as might be used with furniture or wooden fences, may also be used with the embodiments.

The user will pour a designated amount of paint into the paint container. The user can choose to pour to the maximum capacity of the container, or a lesser amount if less is needed or if the weight of a full container is too high. Full capacity preferably means up to a level slightly below tongue bottom edge 54, for example about ¼ inch or ⅜ inch, and not to the very top of the container 10. This level is preferred because paint higher than bottom edge 54 will overlap the tongue portion and interfere with the use of the tongue for dabbing. Further, paint at the bottom edge 54 will overlap the tongue portion when the container is tilted forward. Also, it is preferable for there to be an unfilled but walled space above the maximum paint level so that there will always be some protection against paint spilling out of the container inadvertently as the user moves about. Such a space is available due to continuous wall 14 extending as high as leading edge 52.

When the container is filled with the desired amount of paint, the user can pick it up in one hand, as shown in FIG. 5, and should find that it can be held comfortably. This is because the weight should not be excessively heavy, the gripping portion is formed in a hollowed out space that more closely fits the user's hand and does not require the user's hand to stretch excessively, and further because ridges and possibly a course texture in the gripping portion provides additional grip security. As well, any forward torque should not be excessive, being preferably no more than 1 foot-pound and more preferably less than that. As a result, the user should be able to comfortably move about the paint site for extended periods while holding the paint container 10 in one hand. This may also result in the user experiencing a reduced or substantially eliminated level of strain in the hand or arm holding the paint container, in comparison with the strain that might be experienced from holding a large or small paint can or a container of the prior art.

When the user begins painting, the first step will be to dip the brush in the paint container. This procedure may be efficiently and easily done due to the design of container 10. The paint container has an unobstructed top, unlike some of the prior art, so the user does not have to slow down to check for an obstruction with each dip of the brush. The container is sized to have a reasonable capacity, so that an adequate amount of painting can be done with the container at full or even partial capacity. There may be a slight forward tilt due to the torque operating on the gripping portion. This may be beneficial in that it is easier to insert a brush into an opening that is tilted forward rather than one that is rigidly vertical. In addition, the tilted position may make the contents of the container easier to view by the user. The dipping is also rendered more efficient by the fact that the brush does not have to be re-oriented when it is removed from the container.

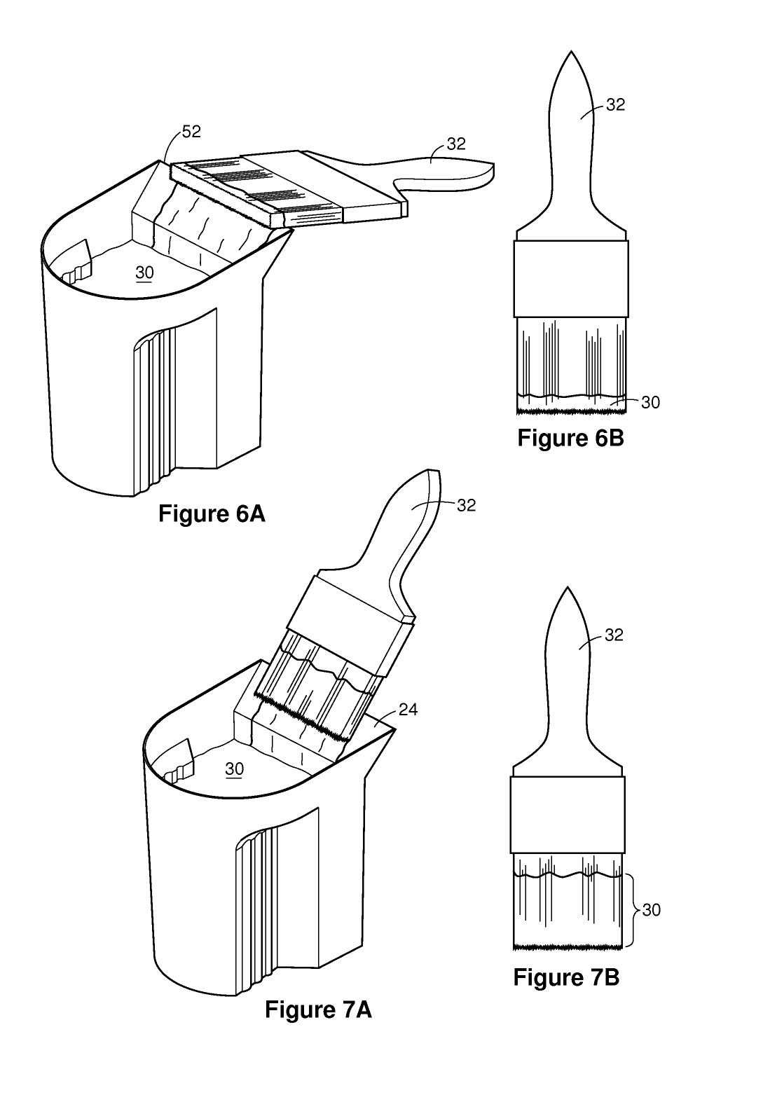

After the brush is dipped, excess paint may be removed and a preferred paint profile achieved by wiping or dabbing the paint brush. As shown in FIG. 6A, the brush bristles may be wiped or scraped against leading edge 52 of the tongue. The excess paint goes onto the tongue and is free to drain into dipping section 22. A sample profile of a wiped brush is shown in FIG. 6B, which shows a brush with a thin line of paint 30 along the bottom edge of the bristles.

If the user needs to dab the brush, the side of the brush may be dabbed against the dabbing surface of the tongue portion 24, as shown in FIG. 7A. It can also be appreciated that the dabbing motion can begin in the same motion by which the dipped brush is removed from the dipping section. For example, the brush can be dragged past the tongue as it is being removed so that all of the side of the brush will be dabbed. A sample profile of a dabbed brush is shown in FIG. 7B, which shows paint 30 on almost the full height of the bristles. The thickness of the paint will be determined by the user according to the degree of dabbing applied.

It can be appreciated that through a combination of wiping and dabbing of the paint brush, an experienced painter can optimize the use of paint, save time in brush preparation, and more effectively paint the surfaces requiring application by brush.

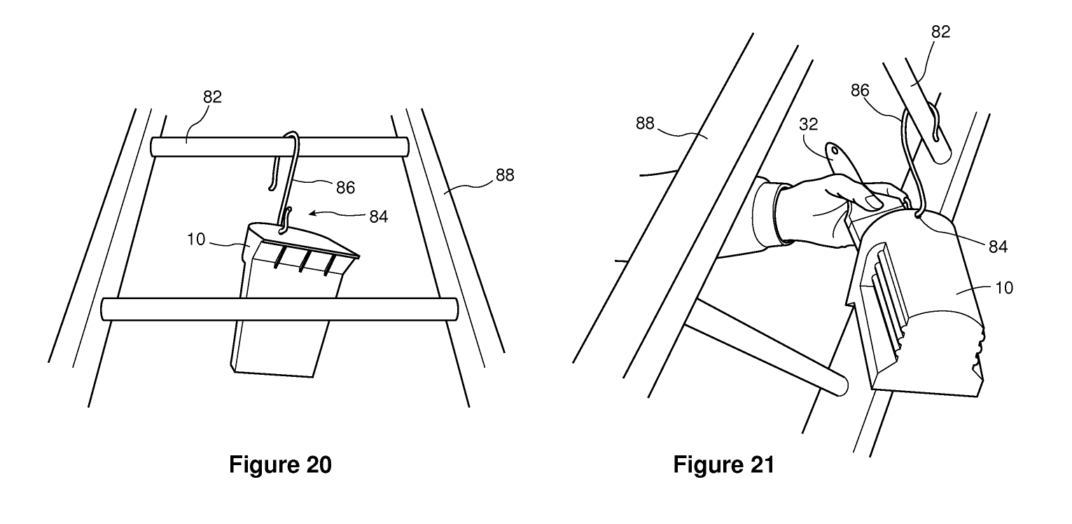

Examples of operation of container 10 when connected to a fixed object 82 (such as a surface, etc.) through the instances of the connector receiver 84 positioned in continuous wall 14 of container 10 are shown in FIGS. 20-24.

FIG. 20 shows container 10 suspended by connector 86 in the form of an S-hook to fixed object 82 in the form of a rung or step of ladder 88. The ladder 88 may be called an extension ladder. It is to be appreciated that connector receiver 84 (aperture) is sized and shaped so that the end of connector 86 (specifically, of the S-hook connector) may be easily slipped in and out of connector receiver 84 (aperture). The “U” shape of the end of connector 86 (S-hook connector) provides a secure connection with connector receiver 84 (aperture), and ensures that container 10 cannot inadvertently slip out of its attachment to connector 86 (hook). FIG. 21 provides a view of container 10 of FIG. 20 in use, showing a painter's hand dipping paint brush 32 into container 10.

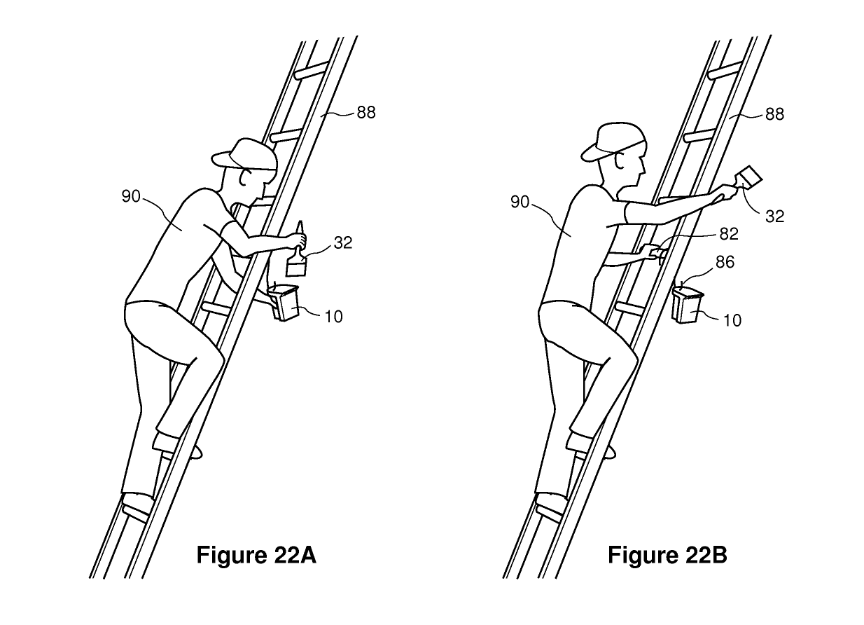

FIGS. 22A and 22B provide a broader view of a user or painter 90 using container 10 suspended from ladder 88. As shown in FIG. 22A, when dipping and wiping the paint brush, painter 90 may use his free (left) hand to hold container 10 so that there is less movement or wobbling by the container. While doing this, painter 90 may optionally lean his or her shoulder or forearm against ladder 88 for improved stability. Then, as shown in FIG. 22B, painter 90 may let go of container 10 and use his free hand to hold onto ladder 88 while applying the paint. From this example it is to be appreciated that container 10 provides an important safety benefit in that painter 90 is able to hold ladder 88 while painting, rather than having to hold the paint container, so that the risk of losing his balance and falling off ladder 88 is greatly reduced.

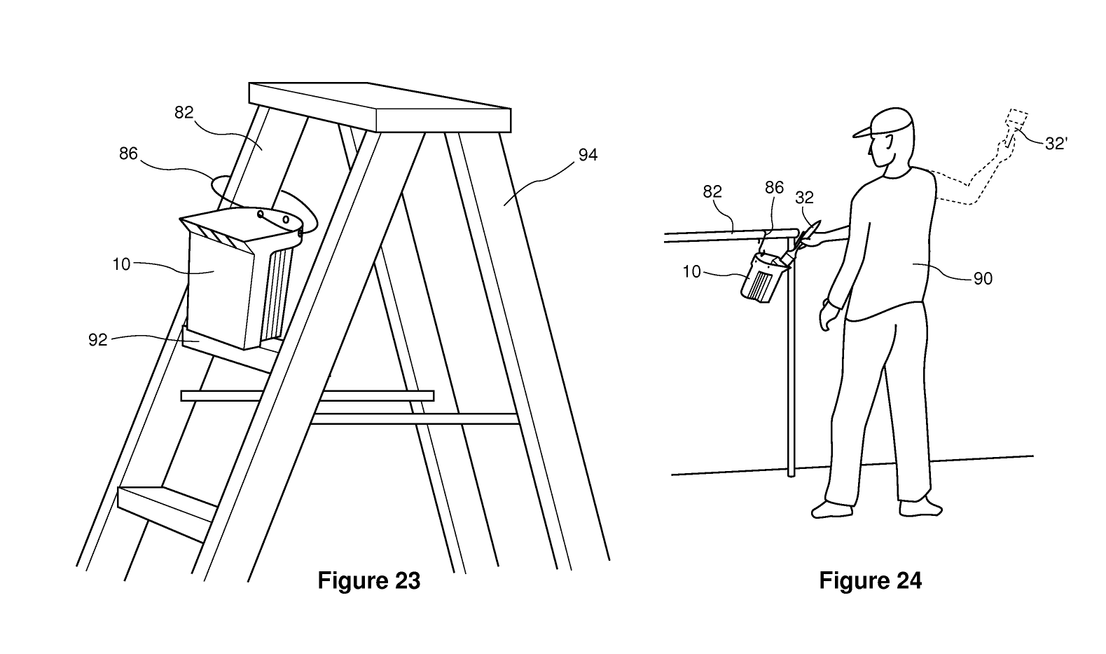

FIG. 23 shows container 10 resting on a step 92 of a step ladder 94 and attached to fixed object 82 in the form of a side-rail of the step ladder. Attaching the container in this way is beneficial in that it prevents the container from falling to the floor and spilling paint in the event that the container or step ladder is inadvertently knocked or struck by the painter or anybody else in the area. Accordingly, it is to be appreciated that the attachability function provided by connector receiver 84 provides certain advantages even when it is not used to suspend container 10 in the air.

Container 10 in this example includes outer aperture pair 84r, located at back end 26 on either side of central, back aperture 84m, as shown in FIGS. 16 and 17. As indicated, connector 86 is a flexible wire which is passed or threaded through both instances of outer aperture pair 84r, rather than through central aperture 84m. As noted above, having two connecting points generally provides a more firm and stable connection to the side-rail instance of fixed object 82 than might otherwise occur if only the single instance of aperture 84m was used. In addition, it can be seen that side-rail instance (example) of fixed object 82 is generally vertically oriented. It is to be appreciated that through use of outer aperture pair 84r, the connector 86 (wire connector) is horizontally oriented, which enables an easier and more natural connection to the vertically oriented step ladder side-rail.

FIG. 24 shows painter 90 using container 10 that is suspended from fixed object 82 in the form of a bar or pipe by connector 86 (the S-hook connector). As indicated, container 10 includes side aperture 84p and side aperture 84q, as shown in FIGS. 15 and 17. The connector 86 (S-hook connector) is connected through side aperture 84p, so that tongue portion 24 is facing to the right. The side aperture 84p and side aperture 84q are examples of connector receiver 84. In this example painter 90 is right handed and painting an area in front or to his right. However, the only convenient available instance of fixed object 82 includes a bar, which happens to be on the painter's left side. If container 10 were connected through aperture 84m, which is located at back end 26, tongue portion 24 would face directly away or perpendicular to fixed object 82 (bar). In that case, painter 90 might have to turn around substantially and/or take a step every time he needs to dip and wipe paint brush 32. In addition to being awkward and requiring more physical effort, such activity would also be time consuming, and thereby increase the total time to complete the paint job.

By taking advantage of side aperture 84p, container 10 can not only be suspended, but also be oriented to the right, which is more convenient for painter 90. As shown, with tongue portion 24 facing right, painter 90 can reach across his body with paint brush 32 to easily dip and wipe the brush without having to turn around to any substantial degree. If desired, painter 90 may hold container 10 with his left hand to reduce wobbling. Then, as shown by the dashed outline of the painters arm and brush 32′, painter 90 can just draw his arm back across his body to paint the required surface in front and/or to his right. It is to be appreciated that if the situation shown in FIG. 24 were reversed, so that painter 90 was left handed, painting an area in front and/or to his left, and where the only convenient instance of fixed object 82 was to his right, then container 10 could be suspended by passing connector 86 through the opposing instance of side aperture 84q, so that tongue portion 24 would face left.

Accordingly, as discussed above, it is to be appreciated that through incorporation of multiple instances of connector receiver 84 (aperture), and in particular apertures positioned or located at back end 26 and in opposing sides, container 10 may be selectively hung or suspended in four mutually perpendicular orientations. This provides painter 90 with options for placement of container 10, so that there is a greater likelihood that a position that is convenient for the particular painting situation may be found by the painter 90. In this way, container 10 may facilitate faster painting, facilitate improved painting efficiencies, and impose less physical strain and stress on the painter 90.

Further, it is to be appreciated that by incorporating gripping portion 20 that is recessed into continuous wall 14, container 10 can include instances of connector receiver 84 that are part of continuous wall 14, particularly at back end 26. Conventional containers typically have or provide a handle that extends out of a back portion of the conventional container. Hanging a conventional container from such a handle, or from an aperture in the handle, may generally not be practical because the lever point would be away from the container body, causing the conventional container to tilt downward at an unacceptably large angle. A large downward tilt is undesirable because it increases the risk of paint spillage.

In sharp contrast, with no external handle in the way, container 10 may include connector receiver 84 (aperture) provided by continuous wall 14 (such as, an aperture defined by continuous wall 14) at back end 26. Container 10 may be suspended from connector receiver 84 (aperture) with reduced downward tilt since the point of suspension may be positioned on the continuous wall 14 of container 10 itself.

Further, when hanging container 10 from a side aperture such as side aperture 84p and side aperture 84q (examples of connector receiver 84) as shown in FIG. 24, container 10 may provide improved balance because there is no distortion caused by weight from an external handle. In addition, when container 10 includes outer aperture pair 84r in a side of the container, as shown for example in FIG. 17, painter 90 may selectively use any one of the three apertures available for attachment to connector 86 (hook). In this way, a further improvement in balance may be achieved.

When the user has completed the paint brushing job, the paint container may be washed and re-used at a later time. Alternatively, since it is preferably made of plastic, it may be discarded and recycled. Due to the expected low cost of the container, it should be relatively convenient to purchase additional containers for other paint jobs or for use with different colours of paint.

### Additional Description

In accordance with an option, container 10 is adapted such that the connector receiver 84 is configured to slidably receive the connector 86. For example, connector 86 in the form of an S-hook or flexible wire will slide inside connector receiver 84 (aperture).

In accordance with an option, container 10 is adapted such that the connector receiver 84 has side walls configured to face the connector 86 once the connector 86 is received by the connector receiver 84.

In accordance with an option, container 10 is adapted such that the connector receiver 84 has side walls configured to conform to the outer shape of the connector 86. For example, where connector receiver 84 in the form of a circular aperture has circular side walls, which conforms to the circular cross section of connector 86 (S-hook, and other hooks with circular cross sections).

In accordance with an option, container 10 is adapted such that the connector receiver is configured to bear or transfer weight of the container to the connector.

In accordance with an option, instances of rib 72 are attached to an outer surface of the inclined tongue portion and to surfaces on either side of the inclined tongue portion.

In accordance with an option, the gripping portion 20 is formed in a hollowed-out section of the wall 14, and the minimum separation distance is at least slightly larger than a length of a portion of the wall between a top opening and the hollowed-out section.

In accordance with an option, the base 12 has a length and the gripping portion 20 extends at least 40% of the length.

In accordance with an option, the gripping portion 20 comprises a recess in wall 14.

In accordance with an option, the gripping portion 20 comprises a first recess and a second recess in wall 14, and the first recess is spaced sufficiently apart from the second recess so as to permit container 10 to be gripped by placement of a thumb of a hand of a user in the first recess and at least one finger of the hand in the second recess.

In accordance with an option, wall 14 has a wall height, and the recess extends upwards from base 12 of container 10 for a distance less than the wall height.

In accordance with an option, gripping portion 20 includes ridges 44 to facilitate gripping of gripping portion 20 by a user.

In accordance with an option, the dipping section 22 has a dipping section width and the inclined tongue portion 24 has a tongue portion width, and the dipping section width is substantially equal to the tongue portion width.

In accordance with an option, container 10 has a center of gravity positioned between the gripping portion 20 and the inclined tongue portion 24, wherein a torque is created about the gripping portion 20 when the container is held by a user at the gripping portion 20, the container being sized and shaped to limit the torque to no more than one foot-pound when the container is full of the paintable liquid 30.

In accordance with an option, the container includes ribs 72 in contact with the wiping edge and tongue portion 24, to provide structural reinforcement and strength to the wiping edge and the tongue portion 24.

It may be appreciated that the assemblies and modules described above may be connected with each other as may be required to perform desired functions and tasks that are within the scope of persons of skill in the art to make such combinations and permutations without having to describe each and every one of them in explicit terms. There is no particular assembly or components that are superior to any of the equivalents available to the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted. It is understood, for the purposes of this document, that the phrase “includes” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

1. An apparatus for use with a paintable liquid and with a connector being configured to connect to a stationary object, the apparatus comprising:
a paint container being configured to operatively contain the paintable liquid once the paintable liquid is received in the paint container to do just so, the paint container including:
a wall being configured to surround, at least in part, the paintable liquid being received in the paint container, the wall including:
a connector receiver being configured to cooperatively engage with the connector once the connector is positioned relative to the connector receiver to do just so, in such a way that the connector connects the connector receiver to the stationary object, and the paintable liquid remains surrounded by the wall and remains within the container.

2. The apparatus of claim 1, wherein the connector receiver includes an outer peripheral edge of an aperture being defined by the wall.

3. The apparatus of claim 1, wherein the connector receiver includes an outer peripheral edge of an aperture being defined by an extension tab being configured to extend from the wall.

4. The container of claim 1, wherein three instances of connector receiver are positioned so that the container is suspendable in any one of four mutually perpendicular orientations.

5. The container of claim 2, wherein the aperture is sized and shaped to receive the connector, and the connector includes any one of a pot hook, an S-hook, a flexible wire, and a bendable coat hanger.

6. The container of claim 2, wherein the aperture is positioned at a back end of the wall.

7. The container of claim 2, wherein an instance of the aperture is positioned at a back end of the wall, and two instances of the aperture are positioned on opposing sides of the wall.

8. The container of claim 1, further including an inclined tongue portion terminating in a leading edge sized and shaped to provide a wiping surface for a brush and having a reinforced lip.

9. The container of claim 8, wherein the reinforced lip comprises an extended upper surface and an extended vertical surface.

10. The container of claim 9, wherein each of the extended upper surface and the extended vertical surface of the reinforced lip have a thickness that is equal to or greater than a thickness of the wall.

11. The container of claim 8, further including a rib sized and shaped to reinforce an inclined tongue portion.

12. The container of claim 1, wherein said wall tapers outwardly as said wall extends up from a base of the container, said wall and a gripping portion being sized, shaped and positioned to permit at least one instance of said container to be stacked inside another instance of said container.

13. The container of claim 12, further including a stop, the stop being sized, shaped, and positioned to prevent the base of a stacked container from getting closer than a minimum separation distance to the base of an adjacent stacked container.

14. The container of claim 13, wherein the stop is a rigid element fixedly attached to the base in an interior space of the container, the stop having an upper surface positioned at a height above the base equal to the minimum separation distance.

15. The container of claim 1, further comprising:
a base, and the wall extends up from the base, the wall forms a top opening;
a gripping portion formed in the wall and being sized, shaped, and positioned to permit a user to grip said gripping means to hold said container;
a dipping section adjacent to said gripping portion, said dipping section being sized, shaped, and positioned to permit a brush to be inserted into said dipping section through said top opening to contact said paintable liquid; and
an inclined tongue portion extending upwardly and outwardly from the wall adjacent to said dipping section, the inclined tongue portion being sized, shaped and positioned to permit the brush to be dabbed thereon to remove excess liquid from said brush, and to permit said excess liquid to drain into said dipping section.

16. The container of claim 1, wherein the connector receiver is configured to slidably receive the connector.

17. The container of claim 1, wherein the connector receiver has side walls configured to face the connector once the connector is received by the connector receiver.

18. The container of claim 1, wherein the connector receiver is configured to transfer weight of the container to the connector.

19. A container for holding paintable liquid, the container comprising:
a body assembly comprising a base and a continuous wall extending up from the base to define a top opening having an outer edge and an interior to hold the paintable liquid;
a gripping portion comprising a recess in the continuous wall and being sized, shaped, and positioned to permit a user to grip said gripping portion to hold said container; and
a wiping edge comprising a portion of the outer edge, the wiping edge being configured to be straight to facilitate wiping of a paint brush, and having a thickness greater than a thickness of the portion of the outer edge that is outside of the wiping edge.

20. A container for holding paintable liquid, the container comprising:
a body assembly comprising a base and a wall extending up from the base to define a top opening and an interior to hold the paintable liquid;
a gripping portion comprising at least one recess in the wall and being sized, shaped, and positioned to permit a user to grip said gripping portion to hold said container;
the wall of the body assembly expanding outwards from the base to the top opening, to facilitate stacking of another container inside the interior of the container; and
a stop located in the interior of the container, the stop being sized and shaped to maintain a minimum separation distance between the base of a first container and the base of a second container stacked inside the interior of the first container.
